(19) United States
(12) Patent Application Publication
(10) Pub. No.: US 2025/0243039 A1
(43) Pub. Date: Jul. 31, 2025

(54) WINCH SYSTEM

(71) Applicant: Automatic Devices Company, Allentown, PA (US)

(72) Inventor: Kevin O'Grady, Allentown, PA (US)

(21) Appl. No.: 18/972,237

(22) Filed: Dec. 6, 2024

Related U.S. Application Data
(60) Provisional application No. 63/606,966, filed on Dec. 6, 2023.

(51) Int. Cl. B66D 1/28; A63J 1/02

(52) U.S. Cl. CPC B66D 1/28; A63J 1/02

(57) ABSTRACT

A winch system may include, but is not limited to: a winch device; one or more load bearing data cables configured to be spooled about a reel of the winch device, the one or more load bearing data cables including: one or more load bearing cables; and
one or more data transfer wires; at least one pipe portion couplable to the one or more load bearing cables, wherein the at least one pipe portion includes one or more data cable connectors coupled to the data transfer wires.

### CROSS-REFERENCE TO RELATED APPLICATIONS

The present application claims priority under 35 U.S.C. § 119 to U.S. Provisional Patent Application Ser. No. 63/606,966, filed Dec. 6, 2023, entitled WINCH SYSTEM, naming Kevin O'Grady as inventor, which is incorporated herein by reference in the entirety.

### TECHNICAL FIELD

The present disclosure generally relates to the field of lift systems for supporting, raising, and lowering performance and concert staging elements.

### BRIEF DESCRIPTION OF THE DRAWINGS

The numerous advantages of the disclosure may be better understood by those skilled in the art by reference to the accompanying figures in which:

FIG. 1 shows a perspective view of a winch system;

FIG. 2 shows a perspective view winch system;

FIG. 3 shows a beam portion of a winch system;

FIG. 4 shows a signal distribution module of a winch system;

FIG. 5 shows a perspective view of a load bearing cable; and

FIG. 6 shows a cross-sectional view of a load bearing cable.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

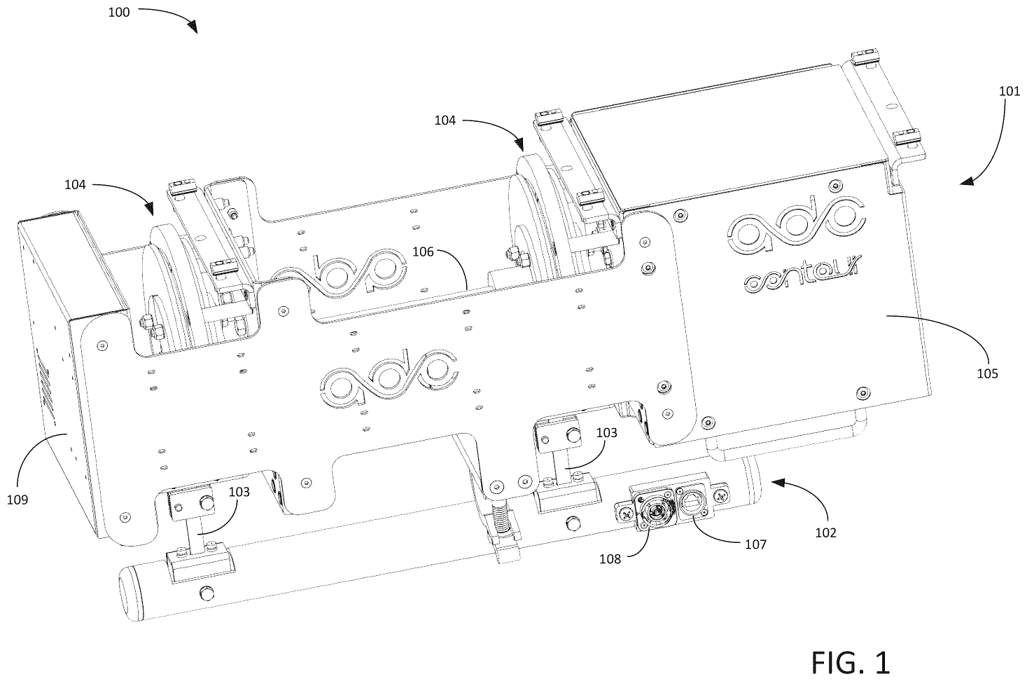

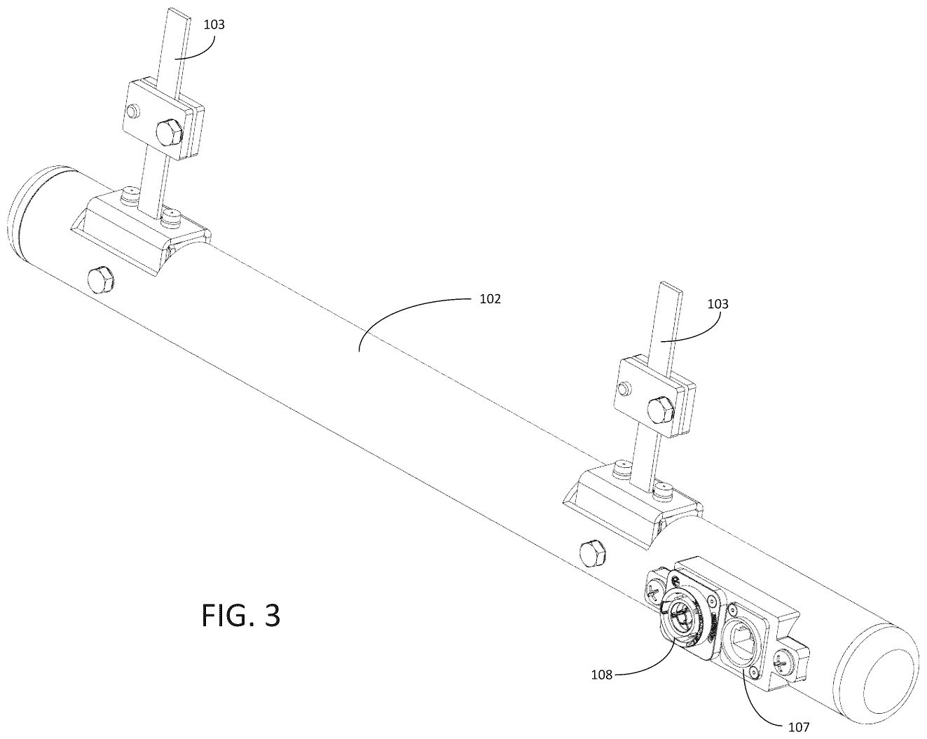

Reference will now be made in detail to the subject matter disclosed, which is illustrated in the accompanying drawings. Referring generally to FIGS. 1 through 6, embodiments of the present disclosure are generally directed to a winch system 100.

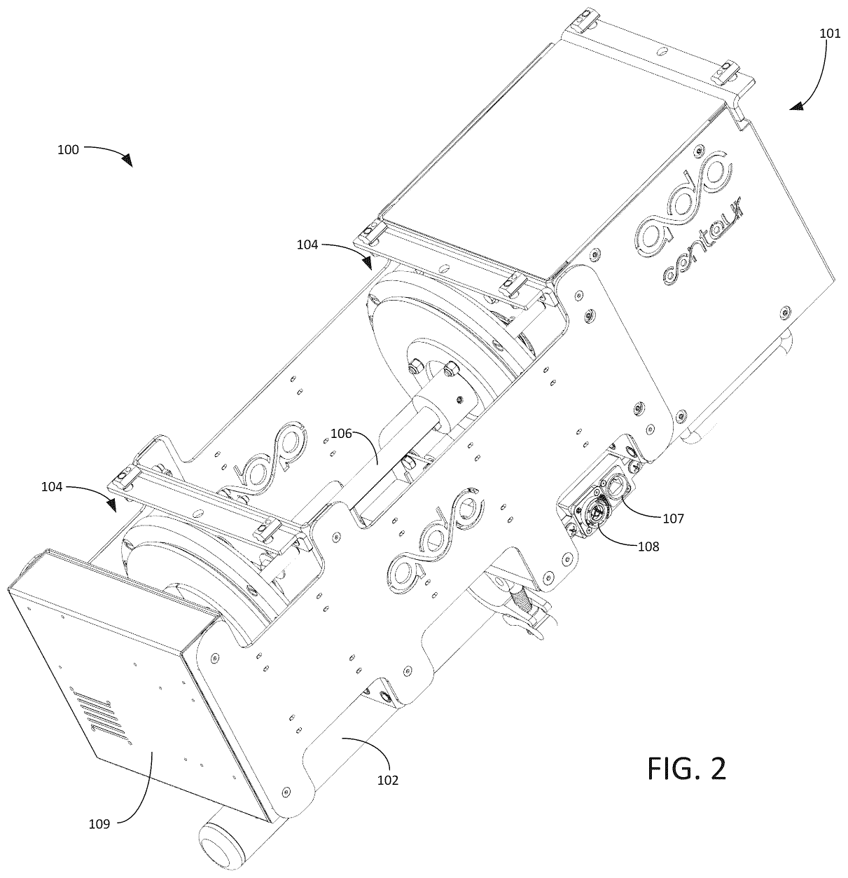

As shown in FIGS. 1 and 2, the winch system 100 may include a winch unit 101 and a beam portion 102 (e.g., a tubular pipe-type member) suspended from the winch unit 101 via one or more load-bearing signal cables 103. The winch unit 101 may include one or more winch reels 104 which may be driven by a winch motor 105. For example, the winch motor 105 may drive a drive shaft 106 operably coupled to the winch motor 105 and the winch reels 104 such that rotation of the drive shaft 106 by the winch motor 105 induces co-rotation of the winch reels 104.

The load-bearing signal cables 103 may be spooled about the winch reels 104 such that rotation of the winch reels 104 causes the load-bearing signal cables 103 to extend or retract.

Referring to FIGS. 1-3, the beam portion 102 of the may include at least one data cabling connector 107 (e.g., a NE8FDY-C6 model RJ45 connector manufactured by Neutrik, and the like) and/or a power cabling connector 108 (e.g., a NAC3FPX-ST-TOP model chassis power connector manufactured by Neutrik, and the like) which may serve to connect various staging items (e.g., lights, speakers, display screens, etc.) mounted on the beam portion 102 to on-unit or remote power or control units via the load-bearing signal cables 103 to enable control of such staging items.

Referring to FIGS. 1 and 2, the winch system 100 may further include a signal distribution module 109 which may serve to distribute power and/or control signals to staging items mounted on the beam portion 102 via the load-bearing signal cables 103.

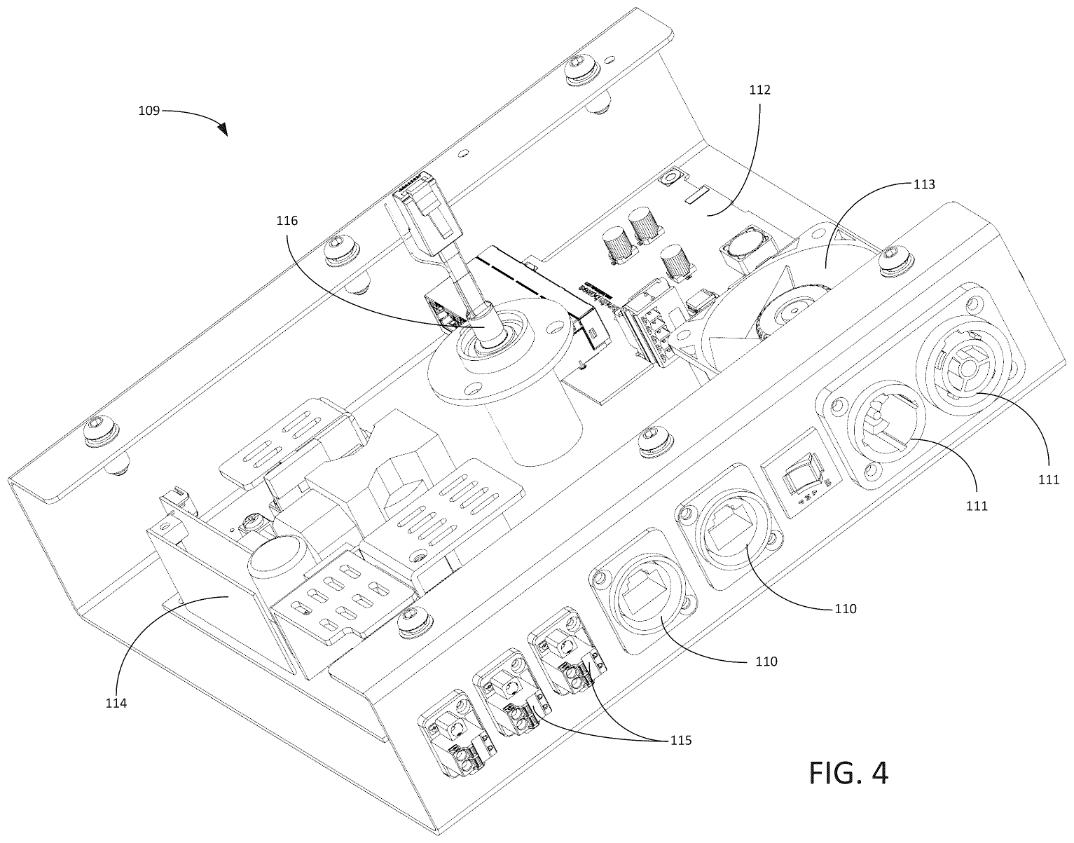

Referring to FIG. 4, the signal distribution module 109 may include various data cabling connectors 110 (e.g., a NE8FDY-C6 model CAT6 Ethernet connectors manufactured by Neutrik) which may receive data cables from a source device to control the staging items. Further, the signal distribution module 109 may include power cabling connectors 111 (e.g., NAC3PX-TOP model appliance inlet-outlet combination power connector manufactured by Neutrik).

Further, the signal distribution module 109 may include an ethernet switch 112 (e.g., an SW-104 model 4-port industrial Ethernet switch manufactured by Brainboxes), a cooling fan 113 (e.g., a 1939K59 model cooling fan manufactured by McMaster-Carr), a power control unit 114 (e.g., an EPP-300 control unit manufactured by Mean Well), and one or more printed circuit board connectors 115 (e.g., FK-MCP 1851232 model PCB connectors manufactured by Phoenix Contact).

Still further, the signal distribution module 109 may include a data cable slip-ring module 116 (e.g., an AC7203 model Ethernet slip ring capsule manufactured by Moog). The slip-ring module 116 may provide a data connection between the signal distribution module 109 and the load-bearing signal cables 103 which are spooled about the winch reels 104. Such a configuration allows the signal distribution module 109 to maintain connection to the load-bearing signal cables 103 even while the winch reels 104 rotate to extend or retract the load-bearing signal cables 103.

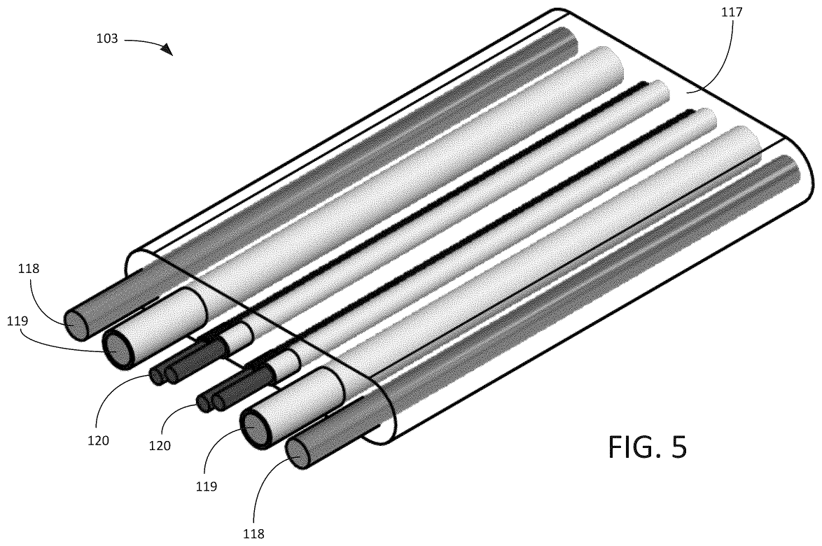

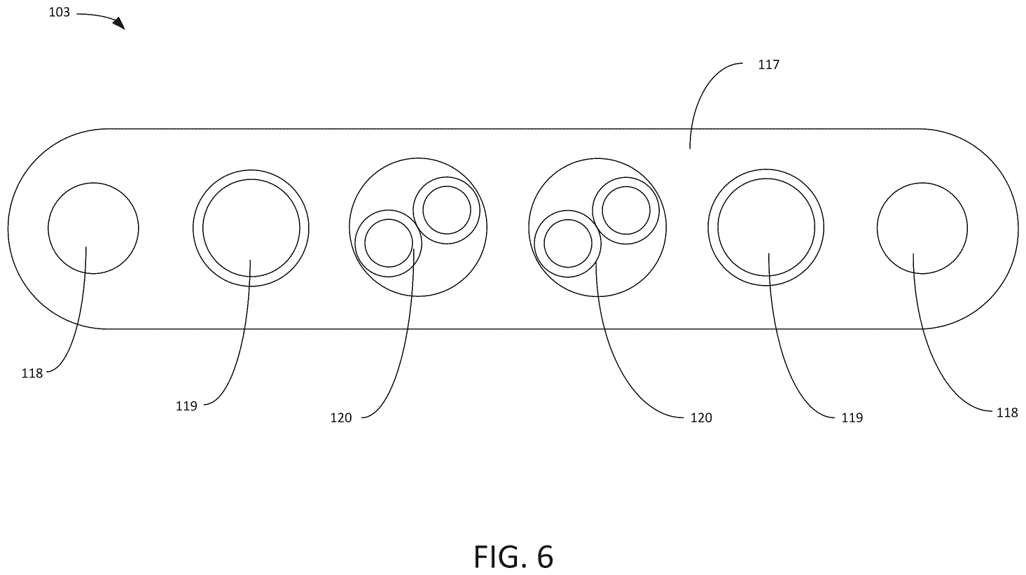

As shown in FIGS. 5 and 6, the load-bearing signal cables 103 may include a jacket layer 117 e.g., a FLEXX-SIL™, SERIES 700X-70 jacket layer manufactured by Cicoil) which may contain one or more load-bearing lines 118 (e.g., 3/64″ 304 stainless steel wire rope), one or more power wires 119 (e.g., 18 AWG, tinned copper wires), and one or more data wires 120 (e.g., 24 AWG, bare copper, twisted pair wires).

The load-bearing lines 118, power wires 119, and data wires 120 may be distributed such that the central axis each is aligned substantially linearly across the cross section of the load-bearing signal cables 103 such that the form factor of the load-bearing signal cables 103 is substantially flat. The power wires 119 and/or data wires 120 of the load-bearing signal cables 103 may be internally connected to the power cabling connector 108 and/or data cabling connector 107 of the beam portion 102.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A winch system comprising:
a winch device;
one or more load bearing data cables configured to be spooled about a reel of the winch device, the one or more load bearing data cables including:
one or more load bearing cables; and
one or more data transfer wires;
at least one pipe portion couplable to the one or more load bearing cables,
wherein the at least one pipe portion includes one or more data cable connectors coupled to the data transfer wires.
